(19) United States
(12) Patent Application Publication
(10) Pub. No.: US 2023/0101307 A1
(43) Pub. Date: Mar. 30, 2023

(54) MODIFIED DUTCH AUCTION SYSTEM WITH OPEN INTEREST INDEX

(71) Applicants: Martin Gammon, Mill Valley, CA (US); Arjun Gupta, Tiburon, CA (US)

(72) Inventors: Martin Gammon, Mill Valley, CA (US); Arjun Gupta, Tiburon, CA (US)

(21) Appl. No.: 17/860,008

(22) Filed: Jul. 7, 2022

Related U.S. Application Data
(60) Provisional application No. 63/219,293, filed on Jul. 7, 2021.

(51) Int. Cl. G06Q 30/08

(52) U.S. Cl. CPC G06Q 30/08

(57) ABSTRACT

A process for determining open interest in an artwork and creating an emerging demand graph or chart is described. This is done by displaying information on the artwork for the public to view. An absentee bidding period is set wherein the online platform accepts absentee bids for the artwork. Certain absentee bids are used to calculate an open interest index in the artwork which is used to adjust the emerging demand graph. This open interest index can be used to measure interest in the artwork before the actual auction of the artwork begins. The actual auction is a modified Dutch auction that uses data from the absentee bidding period, such as the highest absentee bid.

### CROSS-REFERENCE TO RELATED APPLICATIONS

This application claims priority under 35 U.S.C. § 119(e) to U.S. Provisional Application No. 63/219,293 filed Jul. 7, 2021, entitled “ART TECHNOLOGY PLATFORM”, the contents of which are hereby incorporated by reference.

### FIELD OF THE INVENTION

The present disclosure generally relates to a computer system for implementing an auction process for fine art. More specifically, the disclosure relates to software for implementing a modified Dutch auction model with ability to show open interest in the non-fungible items being sold.

### BACKGROUND

Current fine art auction market is highly inefficient and has heavy transactional costs. These inefficiencies are rooted in four key weaknesses of the English Auction Model:

The reserve price is not disclosed;

Open Interest in not disclosed;

Auction estimates are not necessarily pegged to historic pricing trends;

Absentee bids only reach their maximum if a competitive bid falls one increment below that maximum.

These four characteristics create both pricing opacity for most bidders and high “buy-in” (unsold) rates for most sellers, which, coupled with incremental Buyer's Premium rates, discourages competitive bidding in an open and transparent manner.

Auction estimates are a marketing tool designed to coax the maximum number of bidders to participate. As such, they can be highly misleading and often fall well below the final hammer price, or conversely, be artificially inflated and lead to a high “buy-in” rate. As such, depending on auction estimates as a barometer of the final hammer price is one of the chief flaws of the English Auction Model, and frequently misleads bidders into placing bids too low or too high.

In most English Auctions in the fine art category, there is no published measure of current demand, in the form of registered absentee bids or telephone bids on the auctioneer's books. This disenfranchises bidders from being able to calibrate their bids in the face of competition, and conversely also disenfranchises sellers, who cannot convey to bidders if a lot has weak demand and may be acquired at or near the Reserve Price, reducing the risk that the lot will be unsold or ‘bought in’.

In a conventional Dutch auction involving commodities that are interchangeable or fungible, open interest can be disclosed simply by publishing the current ‘bid’ and ‘ask’ of active buyers and sellers. However, Fine Art auctions involve non-fungible objects that are not interchangeable with other objects in the category, and therefore actual bid and ask prices cannot be disclosed prior to the auction without undermining the competitive position of bidders, as there is only one item available.

What is needed is a Dutch auction platform with an open interest on a graduated scale that eliminates lower and redundant bids from the aggregate measure of demand and likewise, weighs successive relevant bids by the strength of the underlying offer price. It would be desirable to enable this without disclosing the underlying bid prices thereby providing an accurate and dynamic window of the emerging demand curve. This benefits both buyers and sellers in achieving a full fair market value in the fine art marketplace.

### SUMMARY

In one aspect, a process for determining open interest in an artwork and creating an emerging demand graph or chart is described. This is done by displaying information on the artwork for the public to view. An absentee bidding period is set wherein the online platform accepts absentee bids for the artwork. Certain absentee bids are used to calculate an open interest index in the artwork which is used to adjust the emerging demand graph. This open interest index can be used to measure interest in the artwork before the actual auction of the artwork begins. The actual auction is a modified Dutch auction that uses data from the absentee bidding period, such as the highest absentee bid.

In one aspect, a modified Dutch auction model, with the disclosure of open interest on a graduated scale measured by the strength of the underlying bids, is a more efficient system in determining true fair market value between buyers and sellers.

In another aspect, a Dutch auction system that exposes the reserve price and current open interest for all bidders will lower the frequency of ‘buy in” or unsold lots compared to English auction models.

The following detailed description together with the accompanying drawings will provide a better understanding of the nature and advantages of the present invention.

### BRIEF DESCRIPTION OF THE DRAWINGS

Various embodiments in accordance with the present disclosure will be described with reference to the drawings, in which:

FIG. 1 is a flow diagram of a process that executes before initiating the modified Dutch auction of the present invention in accordance with one embodiment;

FIG. 2 is a flow diagram showing steps taken in the actual modified Dutch auction in accordance with one embodiment of the present invention; and

FIG. 3 is a block diagram showing hardware and software components and modules in the modified auction platform and system in accordance with one embodiment of the present invention.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

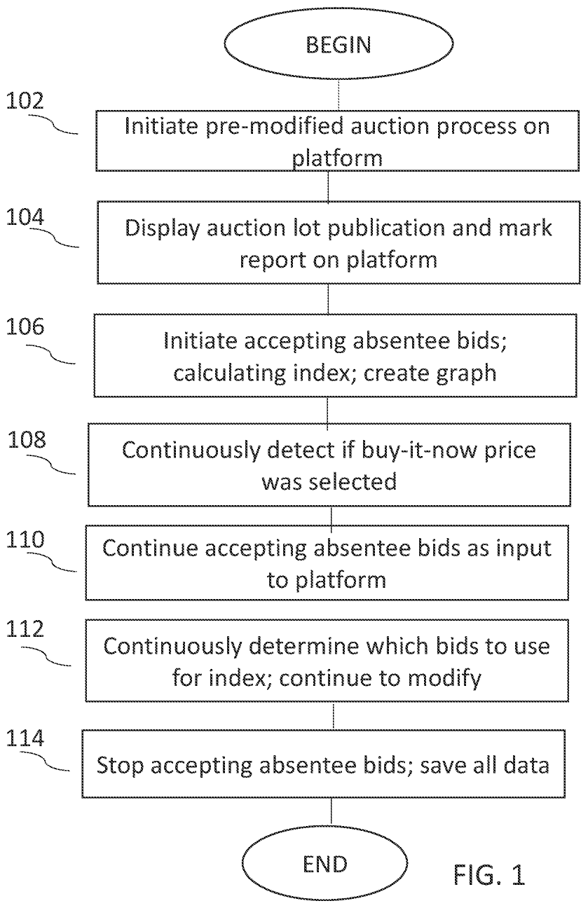

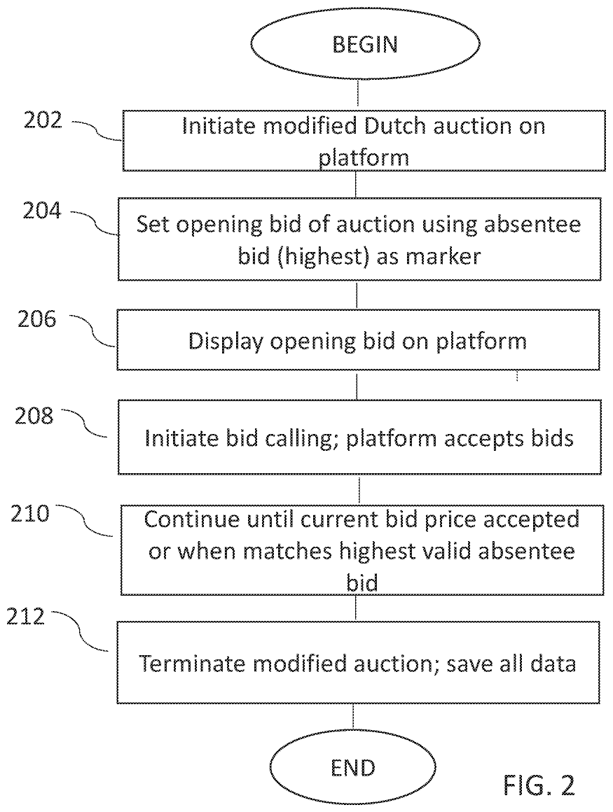

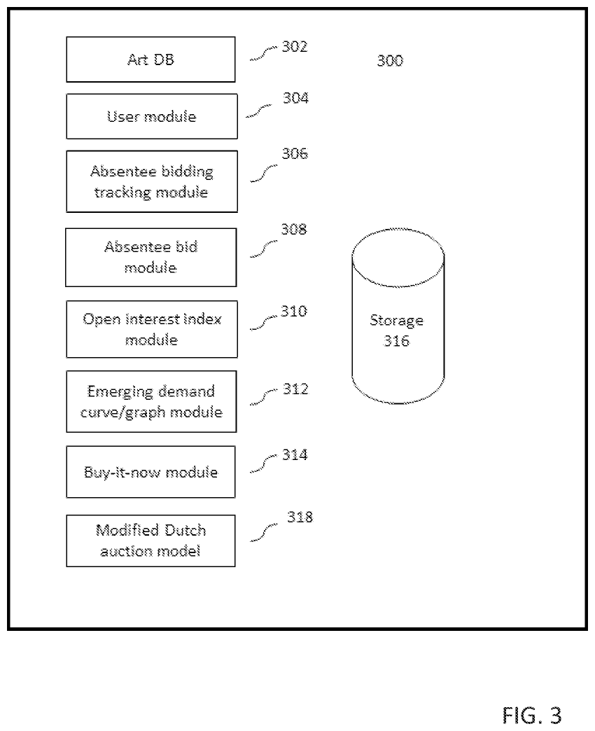

FIG. 1 is a flow diagram of a process that executes before initiating the modified Dutch auction of the present invention in accordance with one embodiment. These are steps taken by running software on a system that prepares for and executes the modified Dutch auction (hereafter referred to as “auction” or “modified auction”) on an auction platform of the present invention. At step 102 the pre-modified auction process initiates. That is, the administrator (equivalent to auctioneer or someone taking direct instructions from an auctioneer) of the system wants to begin a modified auction for a lot or a single piece (for ease of illustration, the invention is described using a single piece). There are steps taken before the modified auction begins, one being initiating execution of the process described in FIG. 1. In general, this pre-auction process involves accepting absentee bids as input to the platform or system and determining a measure of current demand for the piece without disclosing actual bid values. While describing the steps in FIGS. 1 and 2 below, reference is made to components and modules in FIG. 3, a block of the system and platform where the present invention executes, also described separately below. The first step 102 of starting the pre-auction process of accepting absentee bids executes on platform 300 and makes use of several of the components and modules.

At step 104 the administrator posts a pre-auction publication describing the piece (or lot) being sold on the platform. This publication can be seen by anyone visiting the platform Web site. It is intended to inform the public and generate interest. In one embodiment, the pre-auction publication describing the lot has the following information:
1. DESCRIPTION, dimensions and images of the subject property for auction, with all available provenance and related art historical information.
2. Relevant MARKET HISTORY or market comparables of related works
3. PRICING INFORMATION: a presale LOW ESTIMATE, HIGH ESTIMATE, and RESERVE PRICE (minimum bid required to acquire the lot in the absence of competition). The seller also has the option of selecting a BUY-IT-NOW PRICE, which is a preset bid increment that the seller would accept to sell the work outright and cancel the auction prior to the open bidding process.
4. BIDDING RULES, including:
   Any absentee bid placed is your maximum bid in the forthcoming Dutch Auction, which will descend from an elevated opening bid price above the highest placed absentee bid, and descend until a bid is placed live at the auction or meets the highest absentee bid on the books;
   Bids can only be placed at designated bid increments;
   The first bid at a designated bid increment has priority over any later bids at the same increment, in the event it is the maximum bid in the Dutch Auction;
   All bids are subject to a Registration Fee that is non-refundable, on the following scale:
      1% of the bid price up to $10,000;
      0.5% of the bid price between $10,001 up to $100,000;
      0.2% of the bid price between $100,000 up to $1,000,000;
      0.1% of the bid price at or above $1,000,000.

At step 106 the system initiates accepting absentee bids. As noted above, here the “system” refers to all hardware and software components needed to implement the modified auction platform, including connectivity components, storage, algorithms, and a wide range of software modules needed to implement the processes described in the figures. Hardware and software components of the system itself are described throughout and in FIG. 3 below.

The system accepts as input absentee bids from registered bidders. In one

embodiment, a party needs to register with the auction platform by paying a small fee in order to participate in the auction (this registration is not needed to few the pre-auction publication). Typically, a party will study the pre-publication described in step 104 and decide whether she wants to participate in the auction. The requirement to register serves first as a minimal barrier to limit the number of absentee bids thereby reducing the risk of collusion as described below.

Another function that initiates at step 106 is calculation of an open interest index (referred to herein as open index or index) when the first few absentee bids are accepted as input calculating an open interest index begins. Concurrent with initiating calculation of the index is creation of an emerging demand curve or chart, described below. In short, the index provides an accurate and dynamic measure of current demand of the piece that can be seen by the public (not limited to registered bidders) and provides a novel measure of interest without disclosing actual bid values and. of course, without disclosing identities of the absentee bidders. An example of how the index is calculated is provided below. An emerging demand curve manifested in the form of a graph or chart is generated using module 312.

Therefore, at step 106 the open absentee bid period has begun. In one embodiment, the seller can provide via the platform a feature that can be referred to as a Buy-It-Now price. This a price that the seller is willing to sell the piece. If an absentee bidder wants to buy it at that price, the bidder can select the Buy-It-Now option.

At step 108 the system determines whether an absentee bidder has triggered this option executed by module 314. If it has been triggered, the pre-auction process (and by default the actual modified auction) are cancelled for that piece. If the piece is part of a lot, the pre-auction and actual modified auction may continue for the rest of the lot.

At step 110 the open (absentee) bid period is executing on the auction platform 300 in a normal manner using various modules and components in FIG. 3. The administrator determines how long this open bid period will be (e.g., three days). During this time, as absentee bids are entering the system, each bid is processed and the system determines whether the bid should be used to dynamically adjust the index and, concurrently, the graph showing the emerging demand curve using modules 310 and 312. Some bids will be used to adjust the index and others will be deemed redundant or otherwise not applicable by the system for adjusting the index. An example is provided below.

As the emerging demand graph is modified by module 312, it is posted on the platform so it can be seen by the public, not just registered bidders. As noted, this graph, reflective of the current open interest index, is a novel and non-obvious way of showing current open interest or demand for the piece. More specifically, it shows demand dynamically in that it manifests demand/open interest history of the piece starting at the beginning of the open bidding period to the current time.

At step 114 the time period for accepting absentee bids by module 302 has ended. This time may be, for example, 24 hours before the actual modified Dutch auction begins. All the data, including index values, absentee bid values, information on registered bidders, times at which bids were entered, the emerging demand graph, and the like, are saved on the system in memory 316 generally as pre-auction data.

As noted, the index is an accurate measure of demand in the piece and it changes dynamically based on certain absentee bids placed before the actual modified auction. Each bid is weighted by its relevance to the degree of current open interest in the piece.

Absentee bids at the reserve price are limited to one point on the bid increment scale. Only one absentee bid placed at the reserve price counts in calculating the index even if multiple parties place bids at that level. As absentee bids are placed higher on the bid increment scale, they are counted in the index on a graduated basis, with one or more bids at higher levels included in the total. Finally, bids are weighted on the strength of the bid increment against the auction estimate: bids below the low estimate are designated weighted by a factor of 1; those between the low and high estimate designated or weighted by a factor of 2; and those above the high estimate weighted by a factor of 3. These are done by module 310. The designation or weight factors may be different in various embodiments and implementations of platform 300. This allows parties to gauge the current level of open interest in a given piece and adjust absentee bid expectations accordingly. This provides for an efficient and transparent market mechanism for auctioning fine art using a variation of the conventional Dutch auction method.

The primary insight driving the auction platform of the present invention is that the modified auction is more efficient and fairer to both buyers and sellers because a measure of interest in the piece is disclosed before the actual modified auction begins.

To summarize the steps described above, incoming absentee bids are weighted by their relative strength. This is done through the open interest index and emerging demand graph, all without disclosing to other registered bidders the actual bid prices of individual bidders. In one embodiment, an incoming bid is allocated a numerical factor or weight based on its position in the bid increment scale between a reserve price and a high starting price. Bids placed at the reserve or lower price points have a factor of 1 (or other appropriate weight), and only one bid at the lower price range counts as one point toward the measure of the index. Higher bids on the bid interval scale are allocated a numerical factor higher than 1 and the points for multiple bids at the higher price range all count toward the calculation of the index. This scheme of weighting or factoring bids in different ranges and assigning their corresponding points can be described as utilizing a “graduated” scale in calculating the index.

The open interest index of the present invention informs all interested absentee bidders of the current level of demand on a given piece and allows them to then adjust their bidding accordingly.

If there is a high measure of open interest (shown visually in the emerging demand graph), an absentee bidder may decide to place a higher bid in light of that competition or alternatively forego bidding completely. Conversely, if there is very little or no interest in a piece, then a bidder who is willing to place an absentee bid at the disclosed reserve price may do so, alleviating the possibility of a buy-in. In short, the emerging demand curve gives bidders a transparent indication of current demand. It also ensures that the seller gets the highest price possible from the actual state of demand in the marketplace.

In one embodiment, the index is calculated in a sequence of steps described below. Points corresponding to absentee bids are determined and counted on a graduated scale. Their weights depend on where they are between the reserve price and high estimate and above (if applicable). This is done to rule out low bids that are redundant or less relevant to an accurate measure of current open interest. As such, only one bid placed at each bid increment (in the scale) between the reserve price and one increment below the low estimate counts towards the index and will be graded on a scale of 1.0-1.9 depending on where the bids sit on that scale. An example will help illustrate.

For a lot with a low estimate of $10,000, high estimate of $20,000, and a reserve price of $6,000, the first bid placed at $6,000 will be accorded a weight of 1.0 in the index. The first bid of $8,000 will be accorded a grade of 1.5 in the index, and a bid of $9,500 (one bid increment below the low estimate) is weighted 1.9 in the index. The first two bids, each an increment between the low estimate and high estimate, will count towards the index. They each will be weighted on a scale of 2.0-2.9 depending on where they sit on the bid increment scale, as noted above.

Finally, the first three bids, each at an increment at or above the high estimate counts towards the index. They are weighted at a scale of 3.0-3.9, 4.0-4.9, 5.0-5.9, etc., for each band of the variance between the low and high estimate above that level, for example: a bid of $20,000 will have a weight of 3.0 and bid of $30,000 will have a weight of 4.0 (as one band higher than the variance between low and high estimates). A bid of $40,000 will have a weight of 5.0 (as two bands higher than the variance between low and high estimates) and so on. As absentee bids are inputted into the platform before the actual modified auction begins, the index and emerging demand graph evolves and is displayed on the platform. page.

Another feature of the auction platform of the present invention is increment priority bidding. In this feature absentee bids may only be placed on established bid increments; there is no split bidding in one embodiment. The first absentee bid at any increment has priority when the modified auction begins descending from a starting price. This incentivizes absentee bidders to place their maximum bid as soon as possible so that their bids are “first in line” at their maximum price. Unlike the English auction model, where informed bidders are at an advantage when they place their bids at the last possible moment (“bid sniping”), bidders on the modified auction platform of the present invention are incentivized to lock in their maximum bid soon as possible. This allows them to place their bid and be the first at that increment if he or she is the high bidder. This incentive in turn helps to reveal true “open interest” in the piece because most motivated bidders will place bids well in advance of when the actual auction begins.

In one embodiment of the present invention the bid registration fee replaces what is conventionally known as a buyer's premium in the English auction model. Most English auctions charge a significant fee to the buyer above the hammer price, known as “Buyer's Premium,” which in most cases starts out at 25% on the first $100,000, and goes up from there. This significant transactional cost for successful bidders often reduces net results for the seller. In the modified Dutch auction of the present invention, the platform charges every absentee bidder a modest flat registration fee, as noted above (e.g., $10-100) depending on the absentee bid price. This fee registers the bid before the actual modified auction begins. This reduces the number of frivolous or low bids and democratizes the cost structure across the entire bidding population. It also increases the net return to the seller who does not have to part with the “Buyer's Premium” typically paid by the winning buyer to the auction house in the English auction model.

FIG. 2 is a flow diagram showing steps taken in the actual modified Dutch auction in accordance with one embodiment of the present invention. This process is executed by system 300 at a designated time after the absentee bidding period (shown in FIG. 1) closes as set by the platform administrator, for example, 24 hours after the absentee bidding period ends.

At step 202 the system initiates a process to begin the actual modified auction on the platform. As part of this process, the administrator sets an opening bid for the modified auction at step 204. In one embodiment this is done using the highest absentee bid as a metric or marker. For example, the administrator may set the opening bid at a value that is significantly higher than the absentee bid marker. It is important to note that the administrator curates this value using his or her discretion and that it not be done in an automated or calculated manner by the system (to prevent telegraphing or otherwise enabling the public to know or accurately predict what the opening bid may be]. It is at the discretion of the administrator or auctioneer.

At step 206 the opening bid is posted on the platform before bid calling begins.

At step 208 the administrator initiates bid calling on the platform and the system begins accepting actual bids as input. During this stage bids are coming in from registered users, as described above. At step 210, bids are accepted by the platform until a bid is accepted. Once a bid is accepted as the final bid, the modified auction stops. A bid is accepted when a registered bidder accepts the current bid price or when the current bid price matches the highest valid absentee bid.

At step 212 the modified auction stops and the data from steps 202 to 212 are saved in system 300 in memory 316.

FIG. 3 is a block diagram showing hardware and software components and modules in the modified auction platform and system in accordance with one embodiment of the present invention. These components and modules are utilized to implement the functions, algorithms, and features described in FIGS. 1 and 2 and to execute the software and store the various types of data. As will be seen, a single software module may perform multiple different functions and operations available on the platform. Many of these components and modules have already been described while describing the processes in FIGS. 1 and 2.

What is claimed is:

1. A method of determining open interest in an artwork prior to conducting a modified Dutch auction, the method comprising:
displaying artwork data for an artwork to be auctioned on an online platform for public viewing;
accepting absentee bids on the artwork;
calculating an open interest index relating to the artwork wherein an emerging demand curve is modified as the open interest index changes;
detecting if a purchase offer has been made on the artwork and terminating the process if a purchase offer has been made; and
determining which absentee bids to use to calculate the open interest index.
